(19) United States
(12) Patent Application Publication
(10) Pub. No.: US 2022/0377064 A1
(43) Pub. Date: Nov. 24, 2022

(54) METHOD AND SYSTEM FOR MANAGING A WEB SECURITY PROTOCOL

(71) Applicant: PREET RAJ, New York, NY (US)

(72) Inventor: PREET RAJ, New York, NY (US)

(73) Assignee: PREET RAJ, New York, NY (US)

(21) Appl. No.: 17/745,980

(22) Filed: May 17, 2022

Related U.S. Application Data
(60) Provisional application No. 63/191,222, filed on May 20, 2021.

(51) Int. Cl. H04L 9/40; H04L 9/32

(52) U.S. Cl. CPC H04L 63/083; H04L 9/3249

(57) ABSTRACT

Provided is a method for managing a web security protocol that includes receiving a request for a generation of a security token from a client application and further fetching user's permission information from a database based on the received request. The method further includes generating the security token and a refresh token based on the fetched user's permission information and signing them with a private key, and thereby establishing at least one web-socket connection between the client application and a first microservice based on a successful login operation using the signed security token and refresh token to access services associated with the client application. After the establishment, the method furthermore includes monitoring server-side updates associated with a second microservice enabled with server-Side Events (SSE) each time when one of a successful login operation or a log out operation is performed by a user of the client application.

### CROSS-REFERENCE TO RELATED APPLICATION

The present application claims priority to U.S. Provisional Patent Application No. 63/191,222, filed on May 20, 2021, the contents of which are incorporated by reference herein in their entirety.

### FIELD OF THE INVENTION

The present disclosure relates to web application security, and more specifically, to a method and system for managing and creating a web security protocol that is stateless and stateful at the same time.

### BACKGROUND OF THE RELATED ART

Web application security is a branch of information security that deals specifically with the security of websites, web applications, and web services. At a high level, web application security draws on the principles of application security but applies them specifically to internet and web systems. Without a proactive security strategy, businesses risk, the spread and escalation of malware, attacks on other websites, networks, and other IT infrastructures.

The Stateful authentication is commonly used in many applications, especially for applications that do not require scalability too much. Stateful authentication has various advantages including revocation of the session anytime, easy to implement and manage the one-session-server scenario, and the session data can be changed later. However, the Stateful authentication has various disadvantages too in terms of increasing server overhead, lack of scaling, and difficulty for third party applications to utilize the user's credentials.

Stateless authentication is used to solve the above-mentioned disadvantages of the Stateful authentication. They are quite different and are used in different scenarios. Stateless authentication stores the user session data on the client-side (browser). The data is signed by the key of IdP to ensure the integrity and authority of the session data. Since the user session is stored on the client-side, the server has only the capability to verify its validity by checking whether the payload and the signature match. The stateful authentication has various advantages including lower server overhead, easy to scale, and good integration with third-party applications.

However, the stateless authentication has various disadvantages too in terms of revocation of the session anytime, implementation for the one-session-server scenario, and change in session data. The stateless authentication cannot revoke the session anytime. The stateless authentication is relatively complex to implement for the one-session-server scenario. Also, in the stateless authentication, the session data cannot be changed until its expiration time.

Therefore, there lies a need for a method and system that can generate and manage a unique web security protocol that is stateless and stateful at the same time to overcome the disadvantages of the stateful and the stateless authentication.

### SUMMARY

A method for managing a web security protocol includes receiving a request for a generation of a security token from a client application running on a client device. The method further includes fetching user's permission information from a database based on the received request for the generation of the security token and generating the security token and a refresh token based on the fetched user's permission information. The method further includes signing each of the generated security token and the refresh token with a private key and establishing at least one web-socket connection between the client application and a first microservice based on a login operation based on each of the signed security token and refresh token to access services associated with the client application. After the establishment of the at least one web-socket connection between the client application and the first microservice, the method furthermore includes monitoring server-side updates associated with a second microservice enabled with server-Side Events (SSE) each time when one of a successful login operation or a log out operation is performed by a user of the client application.

In a more specific embodiment, the present disclosure describes a web security protocol management system that includes a client device configured to run a client application, and a first microservice that is configured to receive a request for a generation of a security token from the client application running on the client device, and fetch user's permission information from a database based on the received request for the generation of the security token. The system further includes a Rivest-Shamir-Adleman (RSA) based Key pair Module that is configured to sign and encrypt each of the generated security token and the refresh token with a private key. The client device is further configured to establish at least one web-socket connection between the client application and the first microservice based on a login operation based on each of the signed security token and refresh token to access services associated with the client application. The client device is furthermore configured to monitor server-side updates associated with a second microservice enabled with server-Side Events (SSE) each time when one of a successful login operation or a log out operation is performed by a user of the client application.

In another specific embodiment, the present disclosure describes a non-transitory computer-readable medium having stored thereon computer-executable instructions which, when executed by one or more processors, cause the one or more processors to execute operations. The operations comprise receiving a request for generation of a security token from a client application running on a client device and fetching user's permission information from a database based on the received request for the generation of the security token. The operations further comprise generating the security token and a refresh token based on the fetched user's permission information and signing each of the generated security token and the refresh token with a private key. Furthermore, the operations comprise establishing at least one web-socket connection between the client application and a first microservice based on a login operation based on each of the signed security token and refresh token to access services associated with the client application and thereafter comprise monitoring server-side updates associated with a second microservice enabled with server-Side Events (SSE) each time when one of a successful login operation or a logout operation is performed by a user of the client application.

A further understanding of the nature and the advantages of particular embodiments disclosed herein may be realized by reference to the remaining portions of the specification and the attached drawings.

### BRIEF DESCRIPTION OF THE DRAWINGS

FIG. 1 is a block diagram illustrating an example system and accompanying computing environment for managing a web security protocol, in accordance with an embodiment of the present disclosure.

FIG. 2 is a flow diagram of an example method for managing the web security protocol implementable via the example system FIG. 1, in accordance with an embodiment of the present disclosure.

FIG. 3 illustrates a detailed example of message flows between modules of the example system of FIG. 1 to facilitate the generation of the web security protocol, in accordance with an embodiment of the present disclosure.

FIG. 4 is a general block diagram of a computing device usable to implement the embodiments of FIG. 1-3.

### DETAILED DESCRIPTION OF EMBODIMENTS

It should be understood at the outset that although illustrative implementations of the embodiments of the present disclosure are illustrated below, the present invention may be implemented using any number of methods. The present disclosure is not necessarily limited to the illustrative implementations, drawings, and techniques illustrated below, including the exemplary method flow and implementations illustrated and described herein, but may be modified within the scope of the present disclosure.

It is to be understood that as used herein, the terms such as “includes”, “further includes”, “comprises”, “further comprises”,“configured to”, “further configured to”, etc. are intended to mean that one or more features or elements listed are within the element being defined, but the element is not necessarily limited to the listed features and elements, and that additional features and elements may be within the meaning of the element being defined. In contrast, terms such as, “consisting of” are intended to exclude features and elements that have not been listed.

Embodiments of the present invention will be described below in detail with reference to the accompanying drawings.

For the purposes of the present discussion, a microservice may be any computing resource, such as a computer and/or software that is adapted to provide content. e.g., data and/or functionality, to another computing resource or entity that requests it, i.e., the client. A client device may be any computer or system, including a software system that is adapted to receive content from another computer or system, called a computing resource or a server. A server system may be any collection of one or more servers and accompanying computing resources. The terms “client device” and “client” may be employed interchangeably herein, however, depending upon the context in which the term is used, the term client may refer more generally to both client devices and client software or client applications.

For the purposes of the present discussion, a computing environment may be any collection of computing resources used to perform one or more tasks involving computer processing. A computer may be any processor in communication with a memory. A computing resource may be any component, mechanism, capability, or quantities thereof of a computing environment, including, but not limited to, processors, memories, software applications, user input devices, output devices, servers, and so on. Examples of computing resources include data and/or software functionality offered by one or more web services, Application Programming Interfaces (APIs), etc.

For the purposes of the present discussion, a web service may be any computer code and associated functionality that is adapted to be called by an application or other service or process whose code is stored in a separate location (e.g., on another computer or memory storage location or device) from the web service. Accordingly, the term “service” as used herein is relatively broad and may include remotely accessible APIs and/or various other types of interfaces

Embodiments of the present disclosure describe a method for generating and managing a unique web security protocol that is stateless and stateful at the same time. The web security protocol of the present disclosure conveys all the required information for authentication and Server-Side Events (SSEs) from a server to the client for authority updates when a user is deleted, or removed, or their permissions get updated.

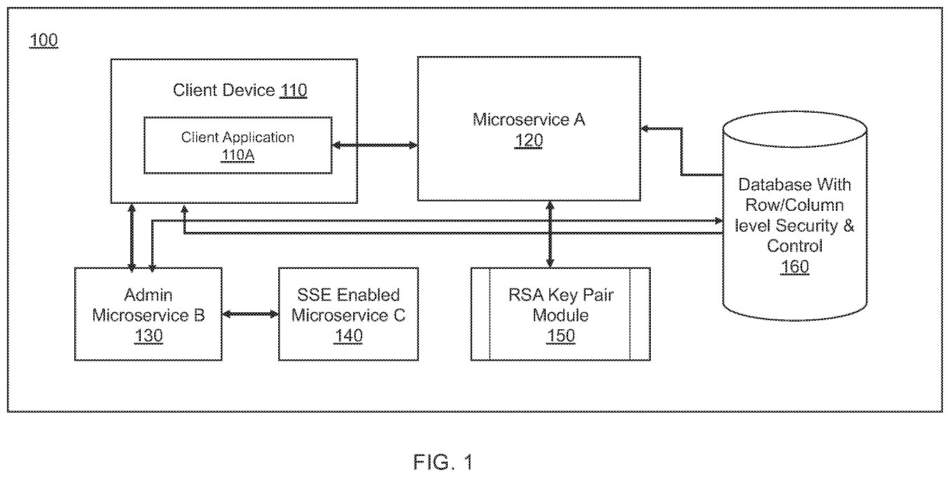

FIG. 1 illustrates an example system 100 illustrating a computing environment for managing a web security protocol, in accordance with an embodiment of the present disclosure. The system 100 includes a Client Device 110 on which a Client Application 110A is running, a Microservice A 120, an Admin Microservice B 130, a server-Side Events (SSE) Enabled Microservice C 140, a Rivest-Shamir-Adleman (RSA) Key Pair Module 150, and a database with Row/Column level security & control 160. The grouping of various components of the system 100 is illustrative and may vary, e.g., certain modules may be combined with other modules or implemented inside of other modules, or the modules may otherwise be distributed differently (than shown) among a network or within one or more computing devices or virtual machines, without departing or deviating from the scope of the present disclosure.

The Client Application 110A may be accessed through different channels, for example, by a user of the Client Device 110. Users may interact with the microservices data server 103 using remote computers. e.g., using a web browser to connect to the servers of the microservices 120, 130, and/or 140 via one or more externally exposed websites or a client application hosted by a web server. The Client Device 110 may be used in concert with the servers of the microservices 120, 130, and/or 140 to access data stored therein, or may be used for other purposes. For example, from Client Device 110 a user may access a web server using an Internet browser, as is known in the art, or by executing a software application that communicates with the webserver and/or data servers over a computer network (such as the Internet).

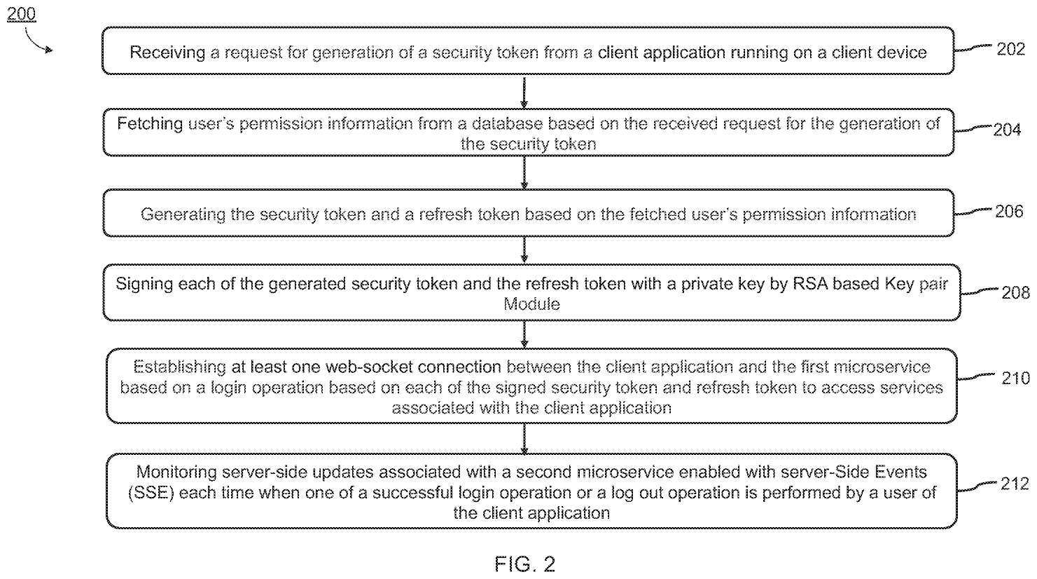

A detailed description of the functionalities and working of the components of the system 100 of FIG. 1 will be described in accordance with the method steps of the method 200 of FIG. 2.

FIG. 2 is a flow diagram of an example method 200 for managing the web security protocol implementable via the example system FIG. 1, in accordance with an embodiment of the present disclosure. In one embodiment, the functionality of the flow diagram of FIG. 2 is implemented by software stored in memory or another computer-readable or tangible medium and executed by a processor. In other embodiments, the functionality may be performed by hardware (e.g., through the use of an application-specific integrated circuit (“ASIC”), a programmable gate array (“PGA”), a field-programmable gate array (“FPGA”), etc.), or any combination of hardware and software.

The method 200 includes (at step 202) receiving a request for generation of a security token (JWT Token) from a client application running on a client device. As an example, the Microservice A 120 receives the request for the generation of the JWT Token from the Client Application 110A running on the Client Device 110.

The method 200 further includes (at step 204) fetching the user's permission information from a database based on the received request for the generation of the security token. As an example, the Microservice A 120 fetches the user's permission information from the database with Row/Column level security & control 160 in response to the request received from the Client Application 110A for the generation of the JWT Token.

The method 200 (at step 206) further includes generating the security token and a refresh token based on the fetched user's permission information. As an example, the Microservice A 120 generates the JWT token and the refresh token based on the user's permission information that is fetched by the Microservice A 120 from the database 160.

The method 200 (at step 208) further includes signing each of the generated security token and the refresh token with a private key. As an example, the RSA Key Pair Module 150 signs/encrypts each of the JWT token and the refresh token with the private key. The Signature is a basic protection that allows token consumers to trust it and to ensure that it has not been tampered with. The signature by the RSA Key Pair Module 150 allows the JWT Token to be validated against any modifications. Encryption, on the other hand, makes sure the content of the JWT Token is only readable by certain parties. The RSA algorithm is a lot faster and the most recommended compared to other algorithms that are used in JWT Token generation.

The method 200 (at step 210) includes establishing at least one web-socket connection between the client application and the first microservice based on a login operation based on each of the signed security token and the signed refresh token to access services associated with the client application. As an example, the Client Device 110 establishes one or more web-socket connections with the Client Application 110A and the Microservice A 120 when the login operation is performed into the Client Application 110A using the signed JWT token and the signed refresh token in order to access one or more services associated with the Client Application 110A.

The method 200 (at step 212) furthermore includes monitoring server-side updates associated with a second microservice enabled with server-Side Events (SSE) each time when a successful login operation or a log-out operation is performed by a user of the client application. As an example, the Client Device 110 monitors the server-side updates of the SSE Enabled Microservice C 140 each of the times when anyone among the login operation or the log-out operation is performed via the Client Application 110A. The SSE Enabled Microservice C 140 transports the updates over simple HTTP instead of a custom protocol.

According to an embodiment of the present disclosure, the SSE Enabled Microservice C 140 can be poly-filled with JavaScript to “backport” SSE to browsers that do not support it yet. It provides built-in support for re-connection and event-id, and there is no trouble with corporate firewalls doing packet inspection when the SSE-based Microservice C 140 is enabled by the Microservice A 120. The SSE Enabled Microservice C 140 is also useful for apps that enable one-way communication of data, e.g., live stock prices

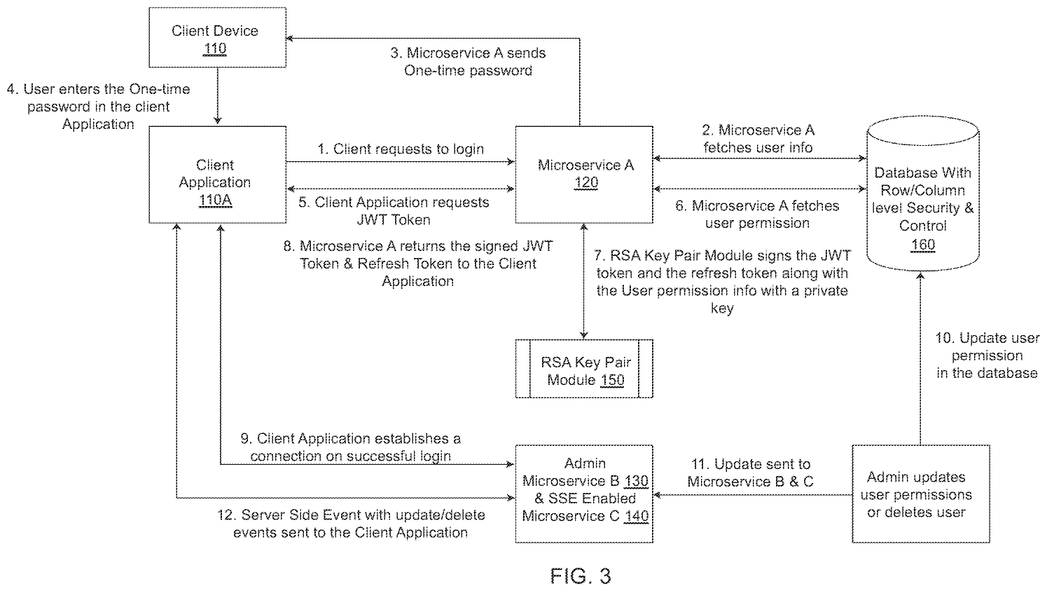

Now a more detailed example of the steps of the method 200 will be described in accordance with FIG. 3 of the drawings for making an understanding of the web security protocol of the present disclosure. FIG. 3 illustrates a detailed example of message flows between modules of the example system of FIG. 1 to facilitate the generation of the web security protocol, in accordance with an embodiment of the present disclosure. FIG. 3 depicts a series of steps 1 to 12 illustrating the corresponding message flows corresponding to each of the modules of the example system of FIG. 1.

In Step 1, the Microservice A 120 receives user input information including the login credentials of the user via the Client Application 110A running on the Client Device 110. For example, when the user logs in using their phone number or an email address into the Client Application 110A and the information including the user's phone number or the email address is sent to the Microservice A 120 from the Client Application.

In Step 2, the Microservice A 120 obtains or fetches, from the database 160, user information associated with the login credentials included in the received user input information.

In Step 3, the Microservice A 120 generates a token (one-time password) for the authentication of the Client Application 110A to the user. Thereby, after the generation of the one-time password, the Microservice A 120 transmits the generated one-time password to Client Device 110 associated with the user on which the Client Application 110A is running.

In Step 4, the user enters the received one-time password in the client Application 110A. Then the one-time password along with the user's phone number or the email address is passed to the Microservice A 120. The Microservice A 120 then takes the user's phone number or the email address along with the one-time password and matches that with a one-way hash stored in the database 160 for that user. Further, the Microservice A 120 validates the one-time password based on the match of the user's phone number or the email address along with the one-time password with the one-way hash.

In Step 5, after the completion of the validation of the one-time password, the client Application 110A requests the JWT Token from the Microservice A 120. Here, the JWT Token can also be referred as a security token without any deviation from the scope of the present disclosure.

In step 6, in response to the received request from the Client Application 110A, the Microservice A 120 fetches the user's permission information from the database 160 for the generation of the JWT Token.

In step 7, the Microservice A 120 generates the JWT token and the refresh token based on the fetched user's permission information, and thereafter the RSA Key Pair Module 150 signs the generated JWT token and the refresh token along with the fetched user's permission information with a private key.

Thereafter in Step 8, the Microservice A 120 transmits each of the signed JWT token and the refresh token to the Client Device 110.

In Step 9, the Client Application 110A running on the Client Device 110 establishes at least one web-socket connection between the Client Application 110A and the Microservice A 120 based on a successful login operation based on each of the signed security token and refresh token to access services associated with the Client Application 110A.

In Step 10, when one of the successful login operation or the log out operation is performed by the user, the Admin Microservice B 130 updates the user's permission information in the database 160. According to an embodiment of the present disclosure, the Admin Microservice B 130 may update the user permissions or delete the user permission when one of the successful login operation or the log out operation is performed by the user of the Client Application 110A.

In one embodiment, the Client Application 110A running on the Client Device 110 keeps monitoring server-side updates associated with the SSE Enabled Microservice C 140 each time when one of the successful login operation or the log out operation is performed by a user of the Client Application 110, when the user permissions are updated, then the Admin Microservice B 130.

In Step 11, each time when the user permissions are updated then the Admin Microservice B 130 and the SSE Enabled Microservice C 140 are updated about the change in the user permissions. The Admin Microservice B 130 may also trigger, based on the updated user's permission information, the SSE Enabled Microservice C 140 to transmit a notification message including the updated user's permission information to the Client Device 110. Since the SSE Enabled Microservice C 140 is being used here, the server can send regular event updates on state changes like user deletion/removal, roles changes, etc.

In one embodiment, the Client Application 110A running on the Client Device 110 keeps monitoring server-side updates associated with the SSE Enabled Microservice C 140 each time when one of the successful login operation or the log out operation is performed by a user of the Client Application.

In step 12, each time when the user permissions are updated (Server-Side event with update/delete events), then the SSE Enabled Microservice C 140 transmits a notification message including the updated user's permission information to the Client Device 110. Thereafter, in response to the notification message, the Client Application 110A running on the Client Device 110 transmits a request for generation of new security token (another JWT Token different from the generated JWT Token) to the Microservice A 120. Thereafter, the Microservice A 120 generates the new JWT token based on the updated user's permission information. The new JWT token is generated within the established Web Socket connection when there is any change/update in the user's permission information.

According to the methods for managing the web security protocol as described above, the present disclosure provides an addition of the Server-Side Events (SSE) component to stateless authentication architecture, making the web security platform use a web-socket session only for certain major changes to the user events. This new proprietary modification to the stateless architecture takes care of all the disadvantages discussed in the background section regarding the stateful and stateless web security authentication protocols. Since, the Server-Side Events (SSE) component is supported by all modern web and native clients (web, mobile, and desktop), thereby making the web security platform to use the web-socket session only for certain major changes to the user events at each of the platforms.

According to the methods for managing the web security protocol of the present disclosure, all of the authorization and authentication can still be done using self-contained JWT tokens and all microservices can follow the standard stateless architecture.

In accordance with the above-described method for managing the web security protocol, a unique web security protocol is provided that is stateless and stateful at the same time. Hence, overcomes all the disadvantages of the stateful and stateless web security authentication protocols.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field-programmable gate arrays (FPGAs) that are persistently programmed to perform the techniques, or may include one or more general-purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices, or any other device that incorporates hard-wired and/or program logic to implement the techniques.

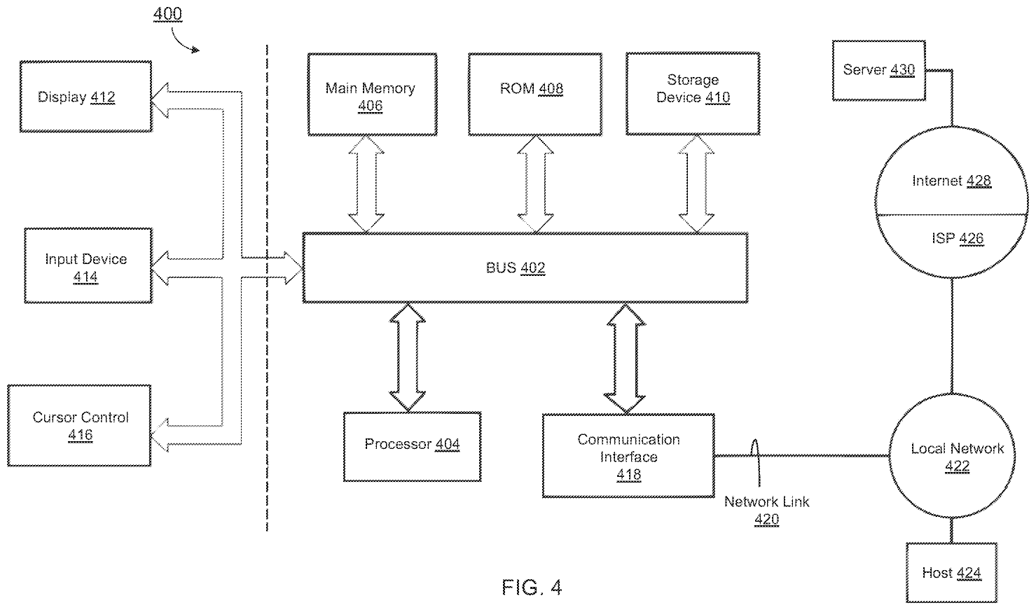

For example, FIG. 4 is a block diagram that illustrates a computer system 400 upon which an embodiment of the invention may be implemented. Computer system 400 includes a bus 402 or another communication mechanism for communicating information, and a hardware processor 404 coupled with bus 402 for processing information. Hardware processor 404 may be, for example, a general-purpose microprocessor.

The computer system 400 also includes a main memory 406, such as a random-access memory (RAM) or another dynamic storage device, coupled to bus 402 for storing information and instructions to be executed by processor 404. Main memory 406 also may be used for storing temporary variables or other intermediate information during the execution of instructions to be executed by processor 404. Such instructions, when stored in non-transitory storage media accessible to processor 404, render computer system 400 into a special-purpose machine that is customized to perform the operations specified in the instructions.

The computer system 400 further includes a read-only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

The computer system 400 may be coupled via bus 402 to a display 412 for displaying information to a computer user. An input device 414, including alphanumeric and other keys, is coupled to bus 402 for communicating information and command selections to the processor 404. Another type of user input device is cursor control 416, such as a mouse, a trackball, or cursor direction key's for communicating direction information and command selections to processor 404 and for controlling cursor movement on display 412. This cursor control 416 typically has two degrees of freedom in two axes, a first axis (e.g., x) and a second axis (e.g., y), that allows the device to specify positions in a plane.

The computer system 400 may implement the techniques described herein using customized hard-wired logic, one or more ASICs or FPGAs, firmware, and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

The Storage media is distinct from but may be used in conjunction with transmission media. Transmission media participates in transferring information between storage media. For example, transmission media includes coaxial cables, copper wire, and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which the processor 404 retrieves and executes the instructions. The instructions received by the main memory 406 may optionally be stored on storage device 410 either before or after execution by processor 404.

The computer system 400 also includes a communication interface 418 coupled to bus 402. The communication interface 418 provides a two-way data communication coupling to a network link 420 that is connected to a local network 422. For example, the communication interface 418 may be an integrated services digital network (ISDN) card, cable modem, satellite modem, or a modem to provide a data communication connection to a corresponding type of telephone line. As another example, the communication interface 418 may be a local area network (LAN) card to provide a data communication connection to a compatible LAN. Wireless links may also be implemented. In any such implementation, the communication interface 418 may send and receive electrical, electromagnetic, or optical signals that carry digital data streams representing various types of information.

The Network link 420 typically provides data communication through one or more networks to other data devices. For example, the network link 420 may provide a connection through local network 422 to a host computer 424 or data equipment operated by an Internet Service Provider (ISP) 426. The ISP 426 in turn provides data communication services through the worldwide packet data communication network now commonly referred to as the “Internet” 428. The Local network 422 and Internet 428 both use electrical, electromagnetic, or optical signals that carry digital data streams. The signals through the various networks and the signals on network link 420 and through the communication interface 418, which carry the digital data to and from computer system 400, are examples of forms of transmission media.

The computer system 400 can send messages and receive data, including program code, through the network(s), the network link 420, and the communication interface 418. In the Internet example, a server 430 might transmit a requested code for an application program through the Internet 428, ISP 426, local network 422, and communication interface 418. The received code may be executed by processor 404 as it is received, and/or stored in storage device 410, or other non-volatile storage for later execution.

Several embodiments are specifically illustrated and/or described herein. However, it will be appreciated that modifications and variations of the disclosed embodiments are covered by the above teachings and within the purview of the appended claims without departing from the spirit and intended scope of the invention.

As would be apparent to a person skilled in the art, various working modifications may be made to the methods in order to implement the inventive concept as taught herein.

Moreover, the actions of any flow diagram need not to be implemented in the order shown, nor do all of the acts necessarily need to be performed. Also, those acts that are not dependent on other acts may be performed in parallel with the other acts.

What is claimed is:

1. A method for managing a web security protocol,
in a web security protocol system that includes a client device on which a client application is running, a first microservice, a Rivest-Shamir-Adleman (RSA) based Key pair Module, comprising:
receiving, by the first microservice, a request for generation of a security token from the client application running on the client device;
fetching, by the first microservice, user's permission information from a database based on the received request for the generation of the security token;
generating, by the first microservice, the security token and a refresh token based on the fetched user's permission information;
signing, by the RSA based Key pair Module, each of the generated security token and the refresh token with a private key;
establishing, by the client device, at least one web-socket connection between the client application and the first microservice based on a login operation based on each of the signed security token and refresh token to access services associated with the client application; and
monitoring, by the client device, server-side updates associated with a second microservice enabled with server-Side Events (SSE) each time when one of a successful login operation or a log out operation is performed by a user of the client application.

2. The method as claimed in claim 1,
wherein the web security protocol system further includes an administrator based microservice, and
wherein when one of the successful login operation or the log out operation is performed by the user, the method further comprises:
updating, by the administrator based microservice, the user's permission information in the database; and
triggering, by the administrator based microservice based on the updated user's permission information, the second microservice that is enabled with the SSE to transmit a notification message including the updated user's permission information to the client device.

3. The method as claimed in claim 2, further comprising:
receiving, by the client device from the administrator based microservice, the notification message including the updated user's permission information;
transmitting, by the client device, a request for generation of new security token to the first microservice based on the updated user's permission information included in the notification message; and
generating, by the first microservice, the new security token based on the updated user's permission information.

4. The method as claimed in claim 1, further comprising:
receiving, by the first microservice, each of the signed security token and refresh token from the RSA based Key pair Module; and
transmitting, by the first microservice to the client device, each of the signed security token and refresh token that is received from the RSA based Key pair Module.

5. The method as claimed in claim 1, wherein, before the reception of the request for the generation of the security token by the first microservice, the method further comprises:
receiving, by the first microservice, user input information including login credentials of the user;
obtaining, by the first microservice from the database, user information associated with the login credentials included in the received user input information;
generating, by the first microservice, a token for authentication of the client application to the user; and
transmitting, by the first microservice, the generated token to the client device associated with the user on which the client application is running.

6. A web security protocol management system, comprising:
a client device configured to run a client application;
a first microservice configured to:
receive a request for a generation of a security token from the client application running on the client device; and
fetch user's permission information from a database based on the received request for the generation of the security token; and
a Rivest-Shamir-Adleman (RSA) based Key pair Module configured to sign and encrypt each of the generated security token and the refresh token with a private key,
wherein the client device is further configured to:
establish at least one web-socket connection between the client application and the first microservice based on a login operation based on each of the signed security token and refresh token to access services associated with the client application; and
monitor server-side updates associated with a second microservice enabled with server-Side Events (SSE) each time when one of a successful login operation or a log out operation is performed by a user of the client application.

7. A non-transitory computer-readable medium having stored thereon computer-executable instructions which, when executed by one or more processors, cause the one or more processors to execute operations, the operations comprising:
receiving a request for generation of a security token from a client application running on a client device;
fetching user's permission information from a database based on the received request for the generation of the security token;
generating the security token and a refresh token based on the fetched user's permission information;
signing each of the generated security token and the refresh token with a private key;
establishing at least one web-socket connection between the client application and a first microservice based on a login operation based on each of the signed security token and refresh token to access services associated with the client application; and
monitoring server-side updates associated with a second microservice enabled with server-Side Events (SSE) each time when one of a successful login operation or a log out operation is performed by a user of the client application.
